(19) United States
(12) Patent Application Publication
(10) Pub. No.: US 2026/0155870 A1
(43) Pub. Date: Jun. 4, 2026

(54) BEAMFORMING INTEGRATED CIRCUITS WITH ROUTING DEVICES

(71) Applicant: Qorvo US, Inc., Greensboro, NC (US)

(72) Inventors: David Warren Corman, Gilbert, AZ (US); John Bellantoni, San Jose, CA (US); Nitin Jain, San Diego, CA (US)

(21) Appl. No.: 19/376,169

(22) Filed: Oct. 31, 2025

Related U.S. Application Data
(60) Provisional application No. 63/727,743, filed on Dec. 4, 2024.

(51) Int. Cl. H04B 7/06; H04B 1/40; H04B 7/0426

(52) U.S. Cl. CPC H04B 7/0617; H04B 1/40; H04B 7/043

(57) ABSTRACT

A beamforming integrated circuit (BFIC), including a first port configured to receive a first radio frequency (RF) signal; a second port configured to receive a second RF signal; and one or more routing devices disposed between the first port and the second port. The one or more routing devices are configured to route one of the first RF signal or the second RF signal to merge with another one of the first RF signal and the second RF signal in a merging line.

### RELATED APPLICATION(S)

This application claims priority to and benefit of U.S. Provisional Application No. 63/727,743, filed Dec. 4, 2024, and entitled “BEAMFORMING INTEGRATED CIRCUITS WITH ROUTING DEVICES,” which is hereby incorporated by reference in its entirety.

### FIELD OF THE DISCLOSURE

The present disclosure relates to radio frequency (RF) devices and systems, in particular, relates to beamforming integrated circuits (ICs) with routing devices to solve cross-over issues in routings.

### BACKGROUND

Beamforming integrated circuits (BFICs) play an important role in modern wireless communication systems, enabling more efficient, directional transmission and reception of signals. Beamforming is used to control the directionality of signal transmission by adjusting the phase and amplitude of signals across an array of antennas. This allows systems to focus the signal energy toward specific directions, improving signal quality, enhancing coverage, and increasing spectral efficiency.

BFICs are specially designed chips that integrate the complex signal processing and control functions required to implement beamforming. These circuits manage multiple antennas, dynamically adjusting the phase and gain of each antenna's signal to form the desired beams. BFICs are critical components in applications such as 5G networks, Wi-Fi, radar systems, and satellite communications.

However, the output signal of an existing BFIC can be affected by non-ideal connections between the existing BFIC and a front-end module (FEM). Thus, a BFIC that is less susceptible to such non-deal connections is desired.

### SUMMARY

An aspect of the present disclosure provides a beamforming integrated circuit (BFIC). The BFIC includes a first port configured to receive a first radio frequency (RF) signal; a second port configured to receive a second RF signal; and one or more routing devices disposed between the first port and the second port. The one or more routing devices are configured to route one of the first RF signal or the second RF signal to merge with another one of the first RF signal and the second RF signal in a merging line.

In some embodiments, the first RF signal and the second RF signal are received at respective ports in different directions.

In some embodiments, the first RF signal and the second RF signal are received at respective ports in a same direction.

In some embodiments, the one or more routing device changes a transmission direction of at least one of the first RF signal or the second RF signal.

In some embodiments, the one or more routing devices comprise: a first routing device disposed between the first port and the merging line, configured to route the first RF signal to the merging line; and a second routing device disposed between the second port and the merging line, configured to route the second RF signal to the merging line.

In some embodiments, the first RF signal is transmitted from a first front-end module (FEM); and the second RF signal is transmitted from a second FEM, the first FEM and the second FEM being aligned in a same direction.

In some embodiments, the first RF signal is transmitted from a first front-end module (FEM); and the second RF signal is transmitted from a second FEM, the first FEM and the second FEM being aligned in opposite directions.

In some embodiments, the first RF signal and the second RF signal have a same polarization.

In some embodiments, the BFIC further includes a third port configured to receive a third RF signal that is transmitted in a different direction than the first RF signal; and a fourth port configured to receive a fourth RF signal that is transmitted in a different direction than the second RF signal. The first routing device is further configured to route the third RF signal to a second merging line; and the second routing device is further configured to route the fourth RF signal to the second merging line.

In some embodiments, the third RF signal and the fourth RF signal are received in respective ports in different directions.

In some embodiments, the third RF signal and the fourth RF signal are received in respective ports in a same direction.

In some embodiments, the first RF signal and the third RF signal are transmitted from a first FEM; the second RF signal and the fourth RF signal are transmitted from a second FEM; and the first FEM and the second FEM are aligned in a same direction.

In some embodiments, the first RF signal and the third RF signal are transmitted from a first FEM; the second RF signal and the fourth RF signal are transmitted from a second FEM; and the first FEM and the second FEM are aligned in opposite directions.

In some embodiments, the third RF signal and the fourth RF signal have a same polarization.

In some embodiments, the one or more routing devices each includes: a first switch configured to be communicatively connected to one of the first RF signal or the second RF signal; and a second switch configured to be communicatively connected to the first switch and the merging line.

In some embodiments, the BFIC further includes an on-chip RF crossover component communicatively connecting the first switch and the second switch.

In some embodiments, the BFIC further includes an electrical interface configured to receive a control signal for controlling a connection between the first switch and the second switch via the on-chip RF crossover component.

In some embodiments, the first switch and the second switch include a single-pole-double-throw switch.

In some embodiments, the one or more routing devices comprise silicon, gallium arsenide, gallium nitride, or a combination thereof.

Another aspect of the present disclosure provides a routing device. The routing device includes a first switch configured to be communicatively connected to a radio frequency (RF) signal; a second switch configured to be communicatively connected to the first switch and a merging line; and an on-chip RF crossover component communicatively connecting the first switch and the second switch in response to a control signal

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1 shows an existing BFIC with connections to FEMs.

FIG. 2 illustrates an exemplary routing device, according to some aspects of the present disclosure.

FIG. 3A illustrates an exemplary BFIC with one or more exemplary routing devices and connections to FEMs, according to some aspects of the present disclosure.

FIG. 3B illustrates a simplified circuit diagram of the BFIC in FIG. 3A, according to some aspects of the present disclosure.

FIG. 4A illustrates another exemplary BFIC with one or more exemplary routing devices and connections to FEMs, according to some aspects of the present disclosure.

FIG. 4B illustrates a simplified circuit diagram of the BFIC in FIG. 4A, according to some aspects of the present disclosure.

FIG. 5A illustrates another exemplary BFIC with one or more exemplary routing devices and connections to FEMs, according to some aspects of the present disclosure.

FIG. 5B shows a simplified circuit diagram of a FEM in FIG. 5A, according to some aspects of the present disclosure.

FIG. 5C illustrates a simplified circuit diagram of the BFIC in FIG. 5A, according to some aspects of the present disclosure.

FIG. 6A illustrates another exemplary BFIC with one or more exemplary routing devices and connections to FEMs, according to some aspects of the present disclosure.

FIG. 6B illustrates a simplified circuit diagram of the BFIC in FIG. 6A, according to some aspects of the present disclosure.

FIG. 7A illustrates another exemplary BFIC with one or more exemplary routing devices and connections to FEMs, according to some aspects of the present disclosure.

FIG. 7B shows a simplified circuit diagram of a FEM in FIG. 7A, according to some aspects of the present disclosure.

FIG. 7C illustrates a simplified circuit diagram of the BFIC in FIG. 7A, according to some aspects of the present disclosure.

FIG. 8A illustrates another exemplary BFIC with one or more exemplary routing devices and connections to FEMs, according to some aspects of the present disclosure.

FIG. 8B illustrates a simplified circuit diagram of the BFIC in FIG. 8A, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

As used herein, “communicatively coupled,” “communicatively connected,” “coupled,” and “connected” can be used interchangeably.

In RF technology, a beamforming IC (BFIC) is often communicatively connected to one or more front-end modules (FEMs) to process the receiver signals from the FEMs. The RF ports on the BFIC, used to receive and/or transmit RF signals with the FEMs, often have fixed locations. Also, the RF ports on the FEMs, used to input and/or output the RF signals, often have fixed locations. Fixed RF port locations on a BFIC and corresponding FEMs can cause the RF signal lines to have crossovers, such that direct RF connection between the BFIC and FEMs are not guaranteed. These RF crossovers are typically required in the host printed circuit board (PCB). This is an undesirable feature because the RF crossover can add cost to the host PCB due to extra board layers and increased manufacturing. The RF crossover can also create gain and phase differences between the RF lines with and without RF crossovers, e.g., asymmetry in phase differences. The RF crossover can also complicate gain/phase/time calibration between RF paths.

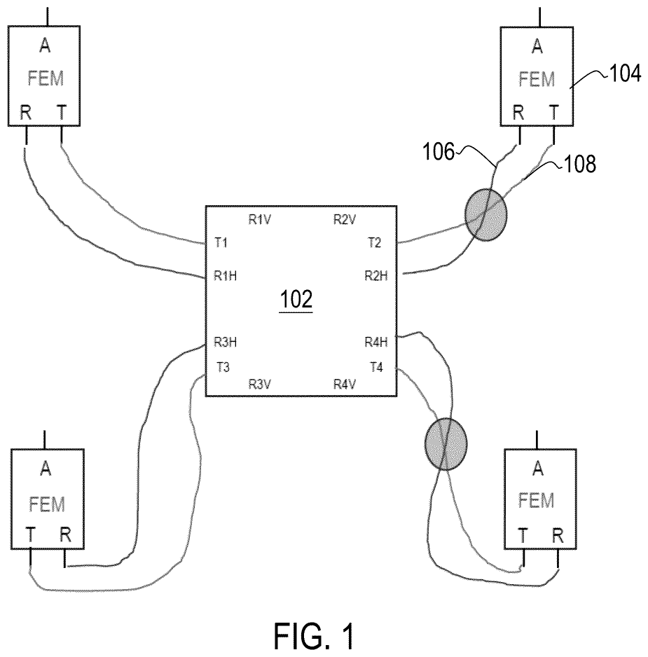

Effort has been made to reduce the crossovers. For example, mirrored FEM layouts can be used to avoid RF crossovers but double the number of FEM part types can increase FEM development cost. FIG. 1 shows an example of a RF crossover between a BFIC 102 and a FEM 104. As shown in FIG. 1, a receiver signal 106 from FEM 104 and a transmitter signal 108 from BFIC has a crossover (marked by the shaded circle). Such crossover can occur between the BFIC and more than one FEMs, causing issues as described above.

Embodiments of the present disclosure provide a BFIC with one or more routing devices integrated within to reduce/eliminate crossovers. A routing device can route a coupled RF signal to a desired direction for the RF signal to be further processed. For example, the routing device can route the RF signal to be merged with another RF signal. In the present disclosure, the routing device may include a plurality of input ports and a plurality of output ports. Each input port may be coupled to a RF signal, while each output port may be coupled to a signal line that the RF signal is rerouted to. The input ports and the output ports may each include switches and can be communicatively connected using an on-chip crossover component. Under a control signal, an input port may be communicatively connected to pre-determined output port, via connected switches, to reroute a RF signal. With the routing device, RF signals between the RFIC and a FEM can be coupled to the RFIC through a port at a desired location to avoid crossovers, while the routing device can reroute a RF signal to a desired signal line regardless of the location. The routing device can provide higher flexibility for the coupling between a FEM and a BFIC while avoiding crossovers. In the meantime, the BFIC can have desirably high dimensional control. Because crossovers can be reduced/eliminated, the complexity of the host PCB can be lowered, resulting in lower cost and reduced system calibration. The line lengths of the RF signals may be desirably easy to match monolithically. The routing device, including a plurality of switches, can be compact in size and low in RF loss.

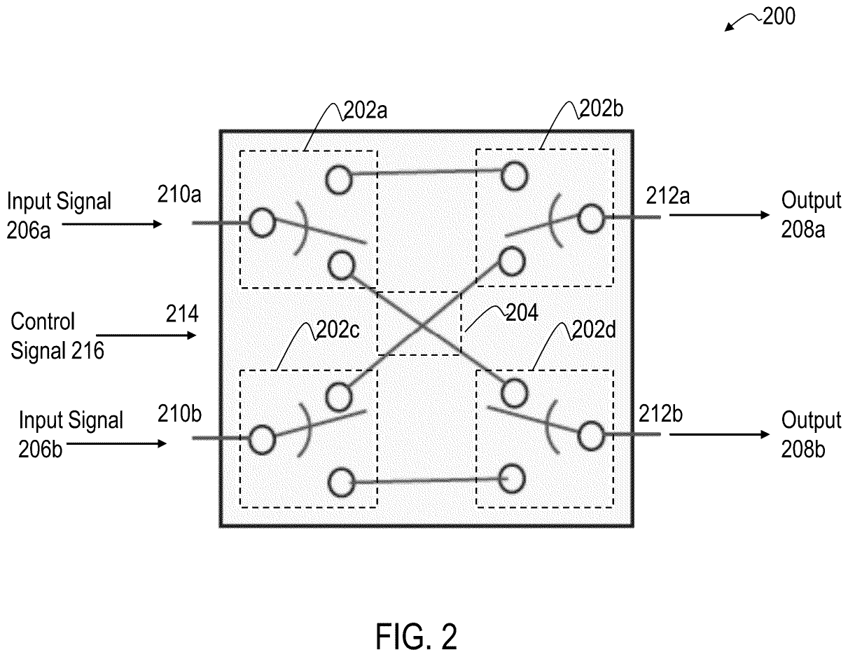

FIG. 2 shows a simplified schematic of an exemplary routing device 200, according to embodiments of the present disclosure. Routing device 200 may also include a plurality of switches, e.g., 202a, 202b, 202c, and 202d, and an on-chip crossover component 204. Routing device 200 may include a plurality of input ports 210a and 210b and a plurality of output ports 212a and 212b, each being a terminal of a switch. The switch at an input port may be communicatively coupled to a switch at an output port via on-chip crossover component 204. Routing device 200 may be configured to receive one or more RF signals and reroute the received RF signals each to a desired signal line.

Specifically, as shown in FIG. 2, switches 202a and 202c may be at the input ports 210a and 210b, respectively. A first terminal of switch 202a may function as or be communicatively coupled to input port 210a, and a first terminal of switch 202c may function as or be communicatively coupled to input port 210b. A second terminal of switch 202a may be communicatively coupled to a first terminal of switch 202b or 202d, and a second terminal of switch 202a may be communicatively coupled to a first terminal of switch 202b or 202d. On-chip crossover component 204 may facilitate the RF coupling between switches 202a and switch 202d, and the coupling between switches 202c and switch 202b. A second terminal of switch 202b may function as or be communicatively coupled to output port 212a, and a second terminal of switch 202d may function as or be communicatively coupled to output port 212b. Routing device 200 may also include an interface 214 for receiving a control signal 216 for controlling the coupling between switches.

Input port 210a may receive an input signal 206a, while alternatively or simultaneously, input port 210b may receive an input signal 206b. If switch 202a is communicatively coupled to switch 202b, input signal 206a may be rerouted to output 208a; and if switch 202a is communicatively coupled to switch 202d, input signal 206a may be rerouted to output 208b. Similarly, if switch 202c is communicatively coupled to switch 202b, input signal 206b may be rerouted to output 208a; and if switch 202c is communicatively coupled to switch 202d, input signal 206b may be rerouted to output 208b. Control signal 216 may include an electrical signal that is received by interface 214 on routing device. Control signal 216 may be synchronized with input signals 206a and 206b to control the coupling between switches to perform beamforming operation.

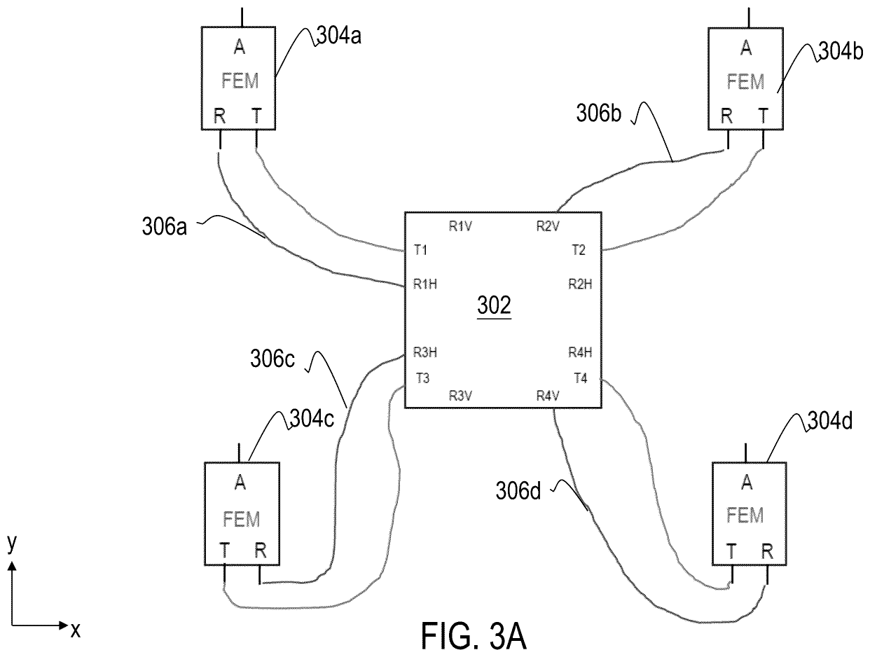

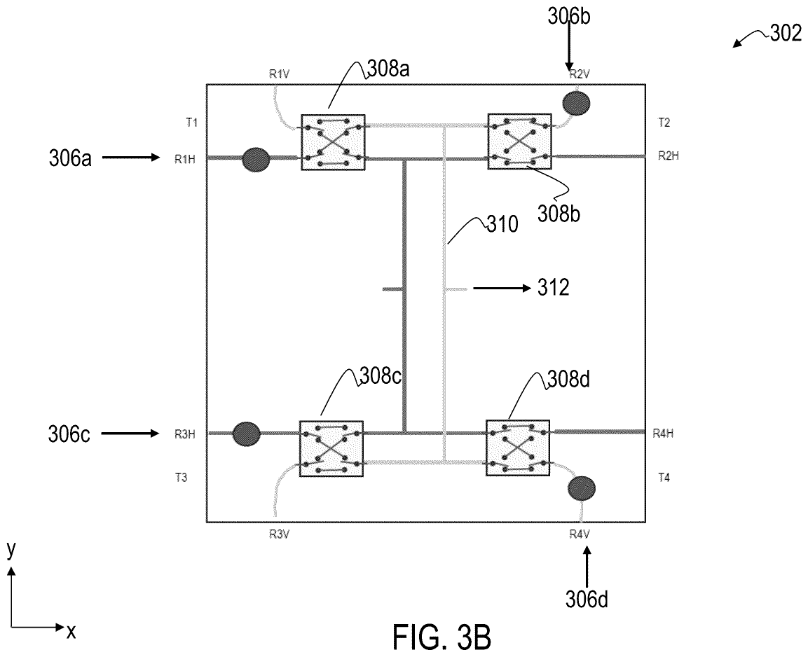

FIGS. 3A and 3B illustrate an exemplary BFIC 302 with one or more routing devices (similar to routing device 200), according to embodiments of the present disclosure. BFIC 302 may be communicatively coupled to a plurality of FEMs 304a, 304b, 304c, and 304d. BFIC 302 may receive receiver signals 306a, 306b, 306c, and 306d from the receiver (or “R”) ports of FEMs 304a, 304b, 304c, and 304d. BFIC 302 may include ports R1H, R2H, R3H, and R4H for receiving receiver signals in a horizontal polarization; and ports R1V, R2V, R3V, and R4V for receiving receiver signals in a vertical polarization. In some embodiments, BFIC 302 transmits transmitter signals to the transmitter (or “T”) ports of FEMs 304a, 304b, 304c, and 304d, respectively.

FEMs 304a-304d may each include an antenna (“A”), and may perform initial processing for the received RF signals. FEM 304a-304d may each include a receiver port (“R”) for outputting a receiver signal and a transmitter port (“T”) for receiving a transmitter signal. In some embodiments, FEM 304a-304d output receiver signals of the same polarization (e.g., vertical polarization or horizontal polarization). In some embodiments, FEMs 304a-304d are aligned in the same physical direction (e.g., the +y direction)

In some embodiments, signals of the same polarization are merged together to be summed up and generate a beam signal. Conventionally, ports R1H, R2H, R3H, and R4H are used to only receive signals of the horizonal polarization, and ports R1V, R2V, R3V, and R4V are used only to receive signals of vertical polarization. However, with the use of routing devices 200, signals of one polarization can be received at a port conventionally for another polarization to avoid crossovers. Specifically, as shown in FIG. 3A, receiver signals 306a-306d may be of the same polarization (e.g., horizontal or vertical polarization), and port R1H may receive receiver signal 306a from FEM 304a, port R2V may receive receiver signal 306b from FEM 304b, port R3H may receive receiver signal 306c from FEM 304c, and port R4V may receive receiver signal 306d from FEM 304d. That is, a receiver signal of one polarization can be routed to a port for another polarization to avoid crossover, while the receiver signal can be rerouted by a routing device at the port to a desired location for further processing such as merging. In the present disclosure, the location of the port to receive a receiver signal is not limited by the embodiments of the present disclosure.

As shown in FIG. 3A, receiver signals 306a-306d (or the lines for transmitting receiver signals 306a-306d) may not have a crossover. As shown in FIG. 3B, BFIC 302 may include a plurality of routing devices 308a, 308b, 308c, and 308d. Routing device 308a may receive receiver signal 306a from a first direction (e.g., x direction) by one input port (e.g., similar to 210b), and output it at one output port (e.g., similar to 212a), which is communicatively coupled to a merging line 310. Similarly, routing device 308b may receive receiver signal 306b from a second direction (e.g., y direction) by one input port (e.g., similar to 210a) and output it at one output port (e.g., similar to 212a); routing device 308c may receive receiver signal 306c from the first direction by one input port (e.g., similar to 210a) and output it at one output port (e.g., similar to 212b); and routing device 308d may receive receiver signal 306d from the second direction by one input port (e.g., similar to 210b) and output it at one output port (e.g., similar to 212b). In some embodiments, the output ports of all routing devices 308a-308d are communicatively coupled to merging line 310, which is used to combine/sum up the rerouted receiver signals 306a-306d. A beam signal 312 may be generated from merging line 310, and has a value of receiver signals (306a+306b+306c+306d). The dots are used to label the receiver signals being summed up. In some embodiments, although shown, ports R1V, R2H, R3V, and R4H are not used.

As shown in FIG. 3B, the rerouting of receiver signals 306a-306d, from various different directions/positions, may be implemented by communicatively coupling a switch at an input port and another switch at an output port. The coupling may be predetermined based on the location of receiver signal, which is further determined to avoid crossover. By placing a routing device between a receiver signal and a merging line, the receiver signal from any suitable location/direction can be rerouted to the merging line to form the beam signal.

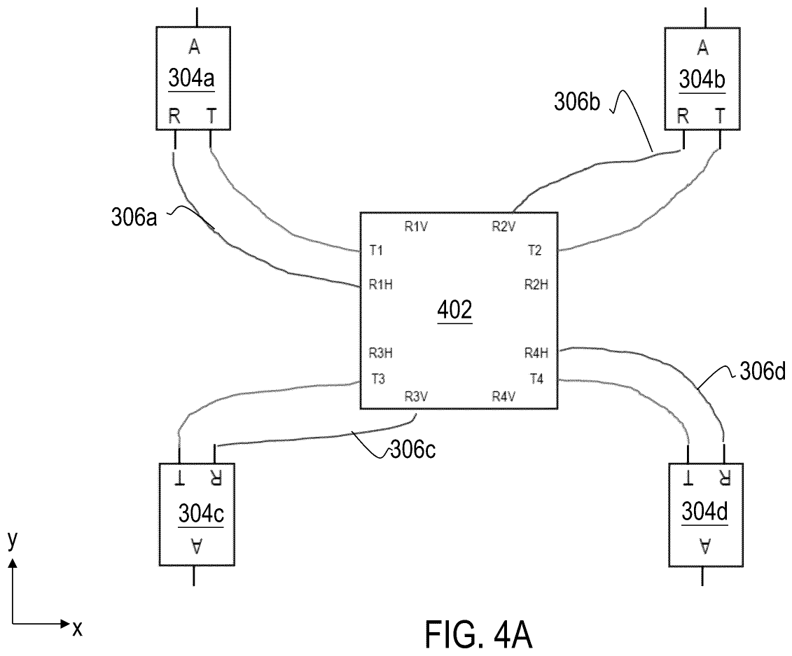

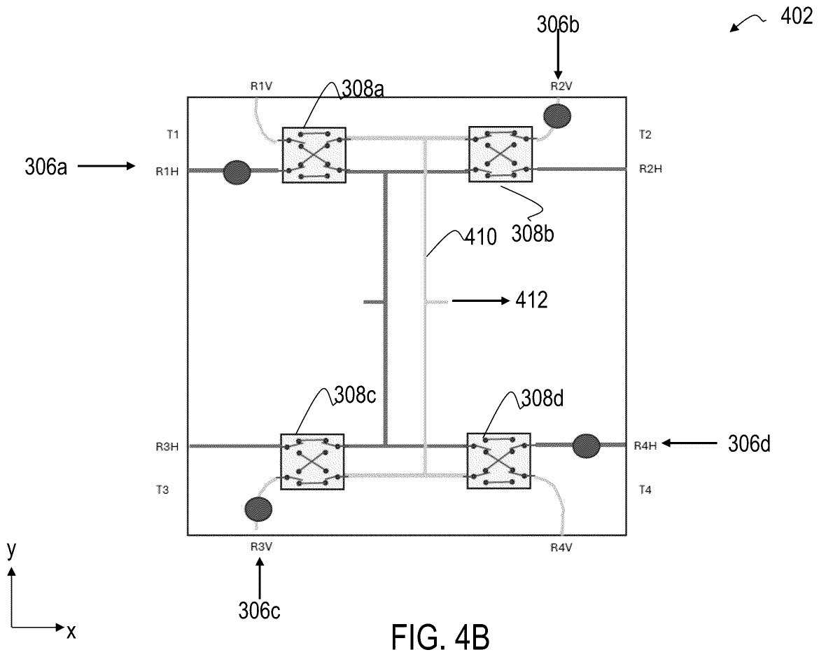

FIGS. 4A and 4B illustrate an exemplary BFIC 402 with one or more routing devices (similar to routing device 200), according to embodiments of the present disclosure. Different from BFIC 302, BFIC 402 may receive receiver signals from FEMs aligned in opposing directions. As shown in FIG. 4A, FEMs 304a and 304b may face the physical +y direction while FEMs 304c and 304d may face the physical-y direction. To avoid crossover between receiver signals, port R1H may receive receiver signal 306a from FEM 304a, port R2V may receive receiver signal 306b from FEM 304b, port R3V may receive receiver signal 306c from FEM 304c, and port R4H may receive receiver signal 306d from FEM 304d.

As shown in FIG. 4B, routing device 308a may receive receiver signal 306a from first direction (e.g., x direction or physical x direction) by one input port (e.g., similar to 210b) and output it at one output port (e.g., similar to 212a); routing device 308b may receive receiver signal 306b from second direction (e.g., y direction or physical y direction) by one input port (e.g., similar to 210a) and output it at one output port (e.g., similar to 212a); routing device 308c may receive receiver signal 306c from the second direction by one input port (e.g., similar to 210b) and output it at one output port (e.g., similar to 212b); and routing device 308d may receive receiver signal 306d from the first direction by one input port (e.g., similar to 210a) and output it at one output port (e.g., similar to 212b). In some embodiments, the output ports of all routing devices 308a-308d are communicatively coupled to a merging line 410, which sums up the rerouted receiver signals 306a-306d. A beam signal 412 may be generated from merging line 410, and has a value of receiver signals (306a+306b+306c+306d). In some embodiments, although shown, ports R1V, R2H, R3H, and R4V are not used.

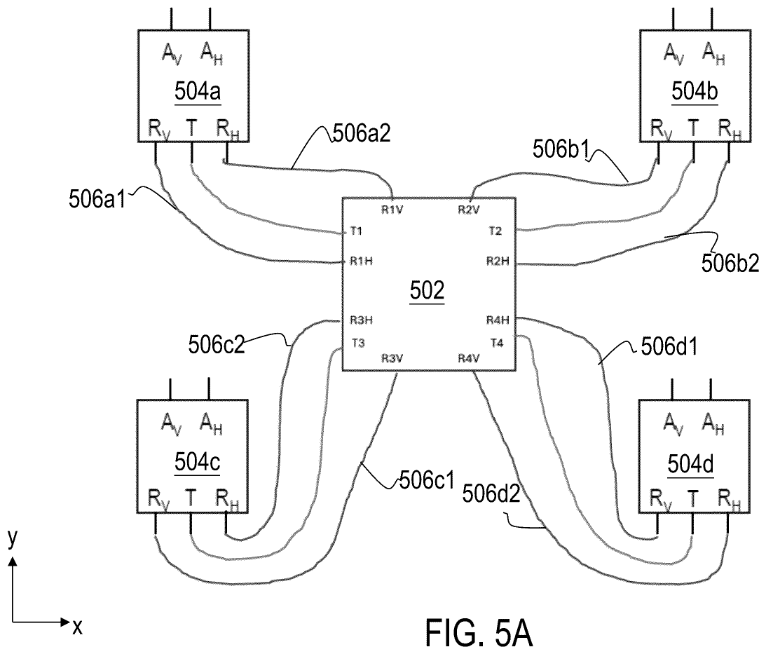

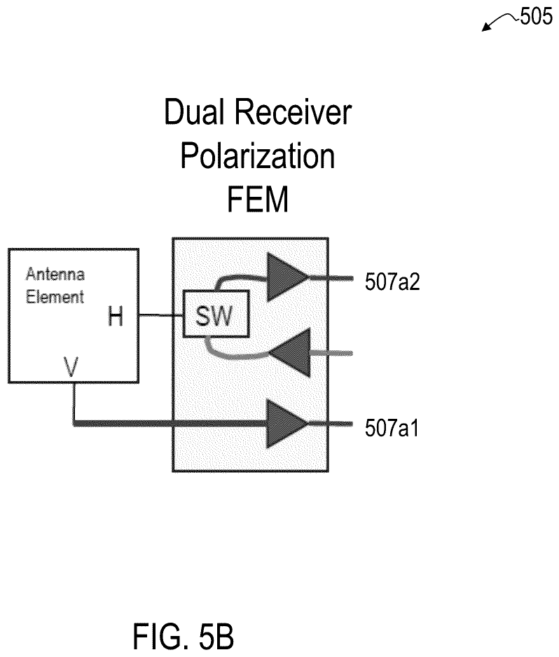

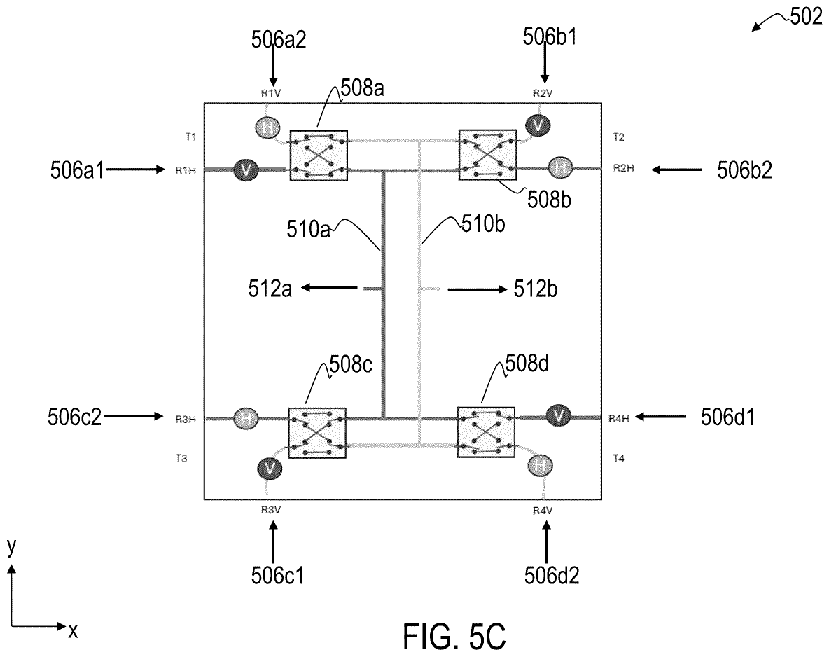

FIGS. 5A, 5B, and 5C illustrate an exemplary BFIC 502 with one or more routing devices (similar to routing device 200), according to embodiments of the present disclosure. Different from BFICs 302 and 402, BFIC 502 may receive receiver signals of two polarizations from FEMs 504a, 504b, 504c, and 504d. As shown FIG. 5A, each FEM (504a/504b/504c/504d) may include an antenna A_{V} for receiving/transmitting signals of vertical polarization, and an antenna A_{H} for receiving/transmitting signals of horizontal polarization. Each FEM may be a “dual receiver polarization FEM” and may include a vertical receiver port R_{V} for outputting a receiver signal of vertical polarization, and a horizontal receiver port R_{H} for outputting a receiver signal of horizontal polarization. FIG. 5B shows a FEM 505, which is an example of each of FEMs 504a-504d. As shown in FIG. 5B, FEM 505 may include a receiver port 507a1 for outputting a receiver signal of vertical polarization, and a receiver port 507a2 for outputting a receiver signal of horizontal polarization. Receiver port 507a1 may be an example of receiver port R_{V}, and receiver port 507a2 may be an example of receiver port R_{H}. In some embodiments, FEMs 504a-504d are aligned in the same direction (e.g., physical +y direction).

To avoid crossover, port R1H may receive receiver signal 506a1 (of vertical polarization) from FEM 504a, port R1V may receive receiver signal 506a2 (of horizontal polarization) from FEM 504a; port R2V may receive receiver signal 506b1 (of vertical polarization) from FEM 504b, port R2H may receive receiver signal 506b2 (of horizontal polarization) from FEM 504b; port R3V may receive receiver signal 506c1 (of vertical polarization) from FEM 504c, port R3H may receive receiver signal 506c2 (of horizontal polarization) from FEM 504c; and port R4H may receive receiver signal 506d1 (of vertical polarization) from FEM 504d, and port R4V may receive receiver signal 506d2 (of horizontal polarization) from FEM 504d.

As shown in FIG. 5C, BFIC 502 may include a plurality of routing devices 508a, 508b, 508c, and 508d. To sum up the receiver signals of vertical polarizations, routing device 508a may receive receiver signal 506a1 from the first direction (e.g., x direction or physical x direction) by one input port (e.g., similar to 210b) and output it at one output port (e.g., similar to 212b); routing device 508b may receive receiver signal 506b1 from the second direction (e.g., y direction or physical y direction) by one input port (e.g., similar to 210a) and output it at one output port (e.g., similar to 212b); routing device 508c may receive receiver signal 506c1 from the second direction by one input port (e.g., similar to 210b) and output it at one output port (e.g., similar to 212a); and routing device 508d may receive receiver signal 506d1 from the first direction by one input port (e.g., similar to 210a) and output it at one output port (e.g., similar to 212a). In some embodiments, the output ports for rerouting the receiver signals of vertical polarization from all routing devices 508a-508d are communicatively coupled to a merging line 510a, which is used to sum up the rerouted receiver signals of vertical polarization 506a1, 506b1, 506c1, and 506d1. A beam signal 512a may be generated from merging line 510a, and has a value of receiver signals (506a1+506b1+506c1+506d1).

To sum up the receiver signals of horizontal polarizations, routing device 508a may receive receiver signal 506a2 from the second direction (e.g., y direction or physical y direction) by another input port (e.g., similar to 210a) and output it at another output port (e.g., similar to 212a); routing device 508b may receive receiver signal 506b2 from the first direction (e.g., x direction or physical x direction) by another input port (e.g., similar to 210b) and output it at another output port (e.g., similar to 212a); routing device 508c may receive receiver signal 506c2 from the first direction by another input port (e.g., similar to 210a) and output it at another output port (e.g., similar to 212b); and routing device 508d may receive receiver signal 506d2 from the second direction by another input port (e.g., similar to 210b) and output it at another output port (e.g., similar to 212b). In some embodiments, the output ports for rerouting the receiver signals of horizontal polarization from all routing devices 508a-508d are communicatively coupled to a merging line 510b, which is used to sum up the rerouted receiver signals of horizontal polarization 506a2, 506b2, 506c2, and 506d2. A beam signal 512b may be generated from merging line 510b, and has a value of receiver signals (506a2+506b2+506c2+506d2).

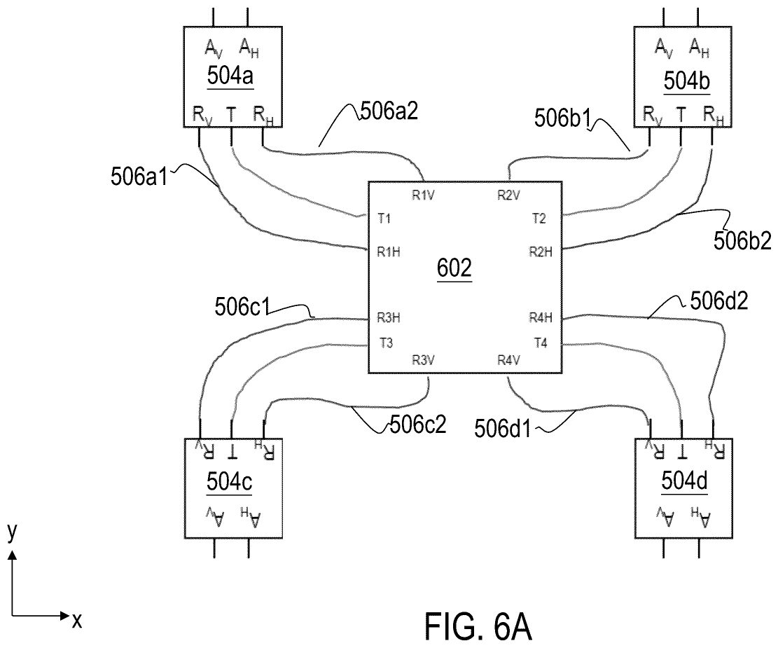

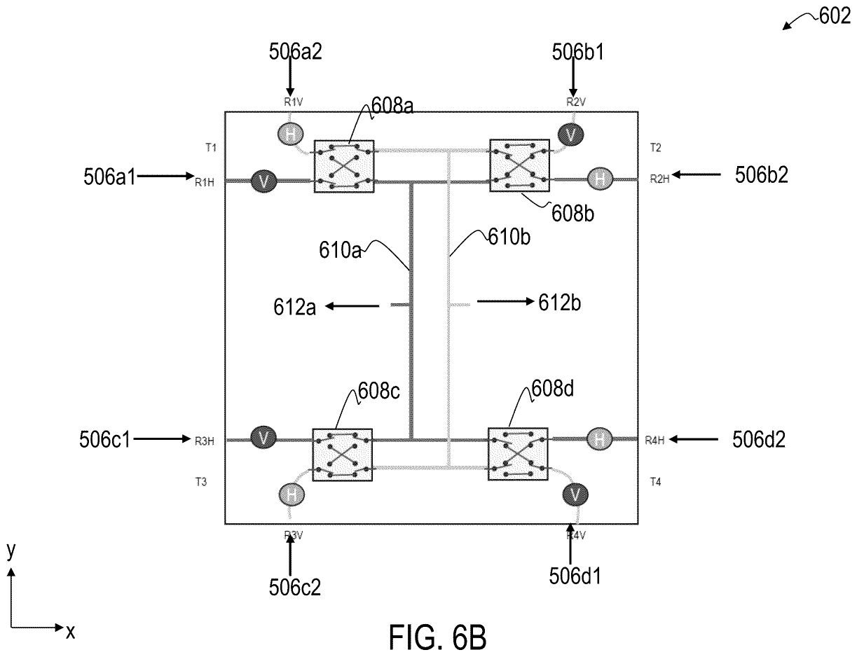

FIGS. 6A and 6B illustrate an exemplary BFIC 602 with one or more routing devices (similar to routing device 200), according to embodiments of the present disclosure. Different from BFICs 502, BFIC 602 may be communicatively coupled to FEMs of opposing directions. As shown in FIG. 6A, FEMs 504a and 504b may be aligned in the +y direction or physical +y direction, and FEMs 504c and 504d may be aligned in the-y direction or physical-y direction. Also, to avoid crossover, port R3H may receive receiver signal 506c1 (of vertical polarization) from FEM 504c, port R3V may receive receiver signal 506c2 (of horizontal polarization) from FEM 504c; and port R4V may receive receiver signal 506d1 (of vertical polarization) from FEM 504d, and port R4H may receive receiver signal 506d2 (of horizontal polarization) from FEM 504d.

As shown in FIG. 6B, BFIC 602 may include a plurality of routing devices 608a, 608b, 608c, and 608d. To sum up the receiver signals of vertical polarizations, routing device 608a may receive receiver signal 506a1 from the first direction (e.g., x direction or physical x direction) by one input port (e.g., similar to 210b) and output it at one output port (e.g., similar to 212b); routing device 608b may receive receiver signal 506b1 from the second direction (e.g., y direction or physical y direction) by one input port (e.g., similar to 210a) and output it at one output port (e.g., similar to 212b); routing device 608c may receive receiver signal 506c1 from the first direction by one input port (e.g., similar to 210a) and output it at one output port (e.g., similar to 212a); and routing device 608d may receive receiver signal 506d1 from the second direction by one input port (e.g., similar to 210b) and output it at one output port (e.g., similar to 212a). In some embodiments, the output ports for rerouting the receiver signals of vertical polarization from all routing devices 608a-608d are communicatively coupled to a merging line 610a, which is used to sum up the rerouted receiver signals of vertical polarization 506a1, 506b1, 506c1, and 506d1. A beam signal 612a may be generated from merging line 610a, and has a value of receiver signals (506a1+506b1+506c1+506d1).

To sum up the receiver signals of horizontal polarizations, routing device 608a may receive receiver signal 506a2 from the second direction (e.g., physical y direction) by another input port (e.g., similar to 210a) and output it at another output port (e.g., similar to 212a); routing device 608b may receive receiver signal 506b2 from the first direction (e.g., x direction or physical x direction) by another input port (e.g., similar to 210b) and output it at another output port (e.g., similar to 212a); routing device 608c may receive receiver signal 506c2 from the second direction by another input port (e.g., similar to 210b) and output it at another output port (e.g., similar to 212b); and routing device 608d may receive receiver signal 506d2 from the first direction by another input port (e.g., similar to 210a) and output it at another output port (e.g., similar to 212b). In some embodiments, the output ports for rerouting the receiver signals of horizontal polarization from all routing devices 608a-608d are communicatively coupled to a merging line 610b, which is used to sum up the rerouted receiver signals of horizontal polarization 506a2, 506b2, 506c2, and 506d2. A beam signal 612b may be generated from merging line 610b, and has a value of receiver signals (506a2+506b2+506c2+and 506d2).

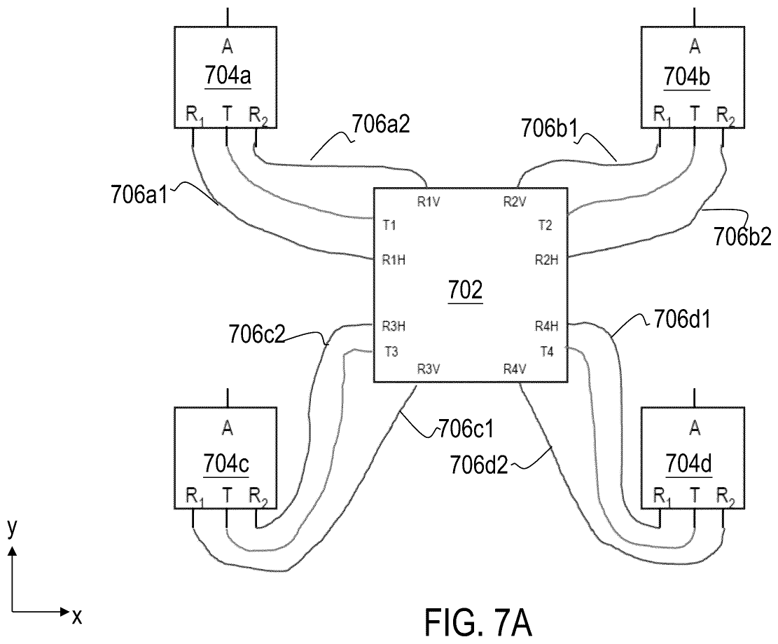

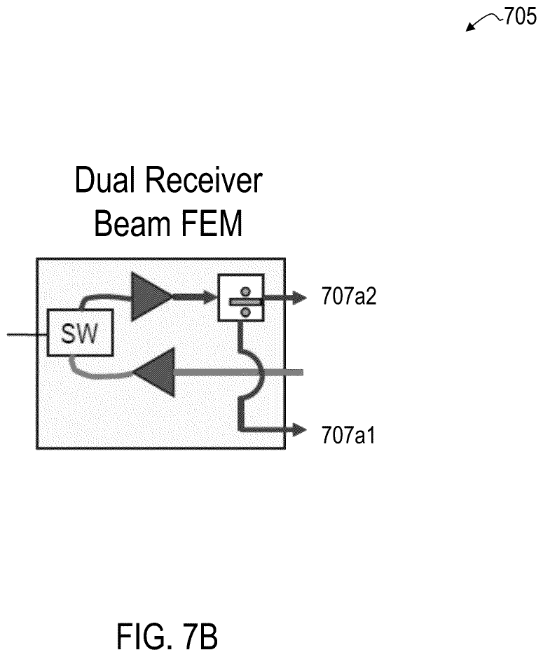

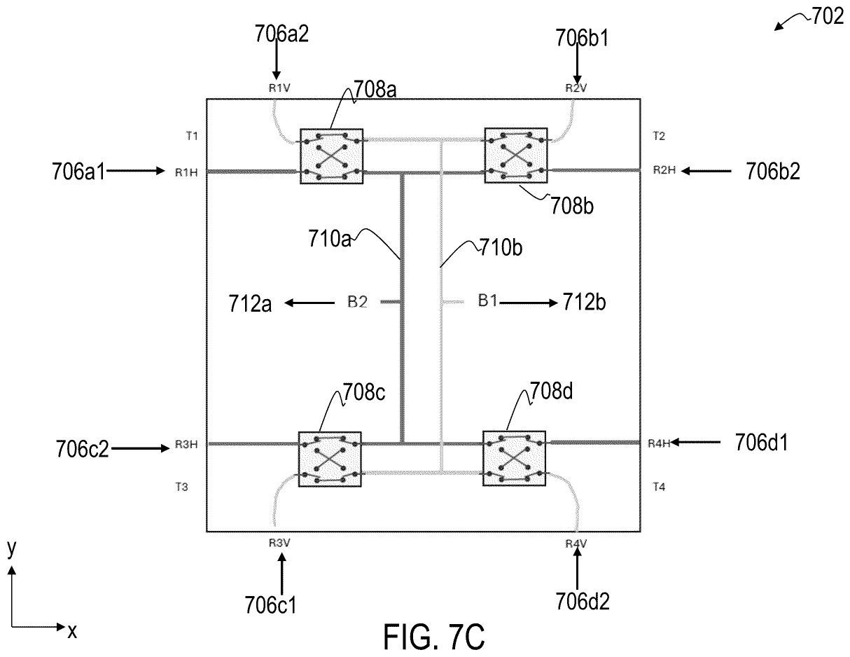

FIGS. 7A, 7B, and 7C illustrate an exemplary BFIC 702 with one or more routing devices (similar to routing device 200), according to embodiments of the present disclosure. Different from BFICs 502 and 602, BFIC 702 may receive receiver signals of a single polarizations from FEMs 704a, 704b, 704c, and 704d. As shown FIG. 7A, each FEM (704a/704b/704c/704d) may include a single antenna A for receiving/transmitting signals of a single polarization (e.g., vertical polarization or horizontal polarization). Each FEM may be a “dual receiver beam FEM” and may include a vertical receiver port R₁ for outputting a first receiver signal, and a second receiver port R₂ for outputting a second receiver signal. FIG. 7B shows a FEM 705, which is an example of each of FEMs 704a-704d. As shown in FIG. 7B, FEM 705 may include a first receiver port 707a1 for outputting a first receiver signal, and a second receiver port 707a2 for outputting a second receiver signal. First receiver port 707a1 may be an example of receiver port R₁, and second receiver port 707a2 may be an example of receiver port R₂. In some embodiments, FEMs 704a-704d are aligned in the same direction (e.g., +y direction or physical +y direction).

To avoid crossover, port R1H may receive first receiver signal 706a1 from FEM 704a, port R1V may receive second receiver signal 706a2 from FEM 704a; port R2V may receive first receiver signal 706b1 from FEM 704b, port R2H may receive second receiver signal 706b2 from FEM 704a; port R3V may receive first receiver signal 706c1 from FEM 704c, port R3H may receive second receiver signal 706c2 from FEM 704c; and port R4H may receive first receiver signal 706d1 from FEM 704d, and port R4V may receive second receiver signal 706d2 from FEM 704d.

As shown in FIG. 7C, BFIC 702 may include a plurality of routing devices 708a, 708b, 708c, and 708d. To generate a first beam signal from receiver signals from the horizontal direction, routing device 708a may receive first receiver signal 706a1 from the first direction (e.g., x direction or physical x direction) by one input port (e.g., similar to 210b) and output it at one output port (e.g., similar to 212b); routing device 708b may receive second receiver signal 706b2 from the first direction by one input port (e.g., similar to 210b) and output it at one output port (e.g., similar to 212b); routing device 708c may receive second receiver signal 706c2 from the first direction by one input port (e.g., similar to 210a) and output it at one output port (e.g., similar to 212a); and routing device 708d may receive first receiver signal 706d1 from the first direction by one input port (e.g., similar to 210a) and output it at one output port (e.g., similar to 212a). In some embodiments, the output ports for rerouting the receiver signals of the horizontal direction from all routing devices 708a-708d are communicatively coupled to a merging line 710a, which sums up the rerouted receiver signals from the horizontal direction 706a1, 706b2, 706c2, and 706d1. A first beam signal 712a may be generated from merging line 710a, and has a value of receiver signals (706a1+706b2+706c2+706d1).

To generate a second beam signal from receiver signals from the vertical direction, routing device 708a may receive first receiver signal 706a2 from the second direction (e.g., y direction or physical y direction) by one input port (e.g., similar to 210a) and output it at one output port (e.g., similar to 212a); routing device 708b may receive first receiver signal 706b1 from the second direction by one input port (e.g., similar to 210a) and output it at one output port (e.g., similar to 212a); routing device 708c may receive first receiver signal 706c1 from the second direction by one input port (e.g., similar to 210b) and output it at one output port (e.g., similar to 212b); and routing device 708d may receive second receiver signal 706d2 from the second direction by one input port (e.g., similar to 210b) and output it at one output port (e.g., similar to 212b). In some embodiments, the output ports for rerouting the receiver signals of the vertical direction from all routing devices 708a-708d are communicatively coupled to a merging line 710b, which is used to sum up the rerouted receiver signals from the vertical direction 706a2, 706b1, 706c1, and 706d2. A second beam signal 712b may be generated from merging line 710b, and has a value of receiver signals (706a2+706b1+706c1+706d2).

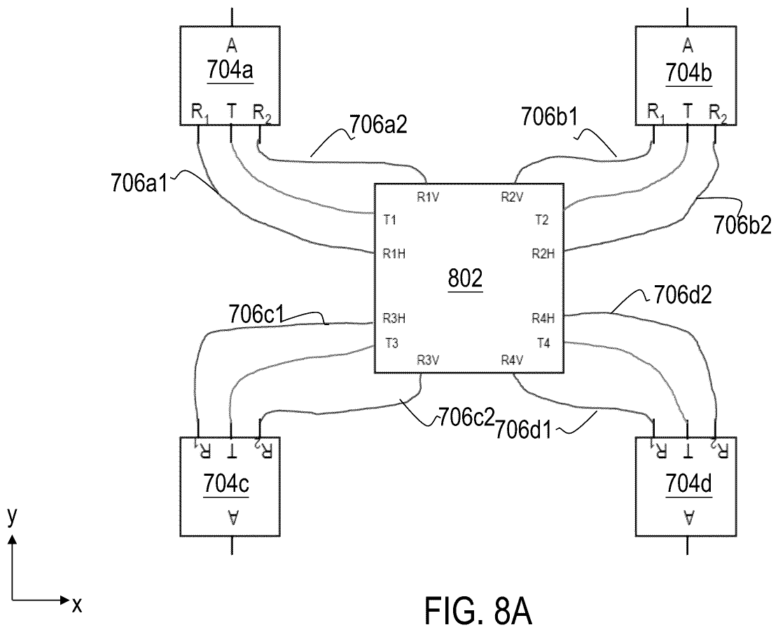

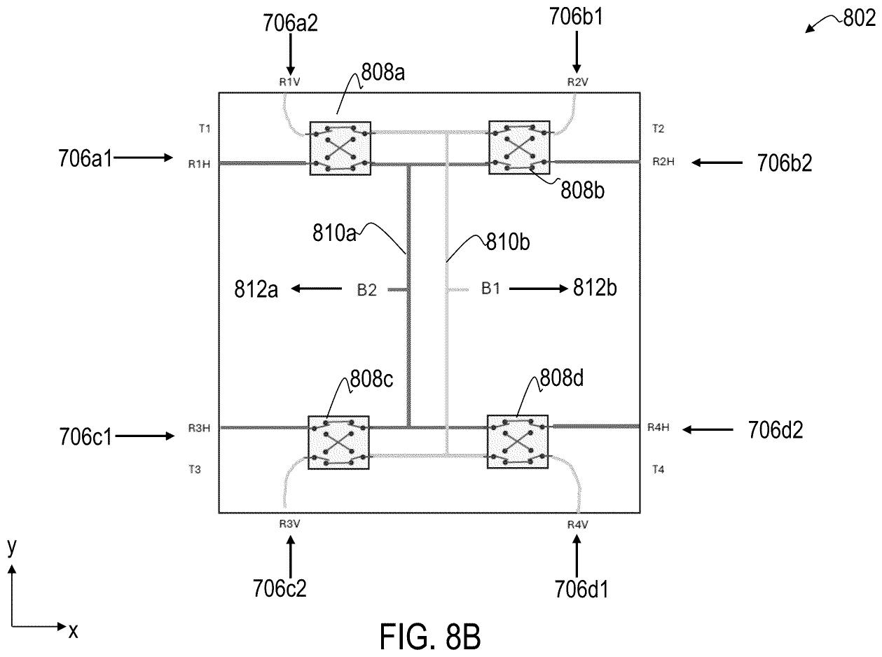

FIGS. 8A and 8B illustrate an exemplary BFIC 802 with one or more routing devices (similar to routing device 200), according to embodiments of the present disclosure. Different from BFICs 702, BFIC 802 may be communicatively coupled to FEMs of opposing directions. As shown in FIG. 8A, FEMs 704A and 704B may be aligned in the physical +y direction, and FEMs 704c and 704d may be aligned in the physical-y direction. Also, to avoid crossover, port R3H may receive first receiver signal 706c1 from FEM 704c, port R3V may receive second receiver signal 706c2 from FEM 704c; and port R4V may receive first receiver signal 706d1 from FEM 704d, and port R4H may receive second receiver signal 706d2 from FEM 704d.

As shown in FIG. 8B, BFIC 802 may include a plurality of routing devices 808a, 808b, 808c, and 808d. To generate a first beam signal from the receiver signals from the vertical direction, routing device 808a may receive second receiver signal 706a2 from the second direction (e.g., physical y direction) by one input port (e.g., similar to 210a) and output it at one output port (e.g., similar to 212a); routing device 808b may receive first receiver signal 706b1 from the second direction by one input port (e.g., similar to 210a) and output it at one output port (e.g., similar to 212a); routing device 808c may receive second receiver signal 706c2 from the second direction by one input port (e.g., similar to 210b) and output it at one output port (e.g., similar to 212b); and routing device 808d may receive first receiver signal 706d1 from the vertical direction by one input port (e.g., similar to 210b) and output it at one output port (e.g., similar to 212b). In some embodiments, the output ports for rerouting the receiver signals from the vertical direction of all routing devices 808a-808d are communicatively coupled to a merging line 810a, which sums up the rerouted receiver signals from the vertical direction 706a2, 706b1, 706c2, and 706d1. A first beam signal 812a may be generated from merging line 810a, and has a value of receiver signals (706a2+706b1+706c2+706d1).

To sum up the receiver signals from the horizontal direction, routing device 808a may receive first receiver signal 706a1 from the first direction by another input port (e.g., similar to 210b) and output it at another output port (e.g., similar to 212b); routing device 808b may receive second receiver signal 706b2 from the first direction by another input port (e.g., similar to 210b) and output it at another output port (e.g., similar to 212b); routing device 808c may receive first receiver signal 706c1 from the first direction by another input port (e.g., similar to 210a) and output it at another output port (e.g., similar to 212a); and routing device 808d may receive second receiver signal 706d2 from the first direction by another input port (e.g., similar to 210a) and output it at another output port (e.g., similar to 212a). In some embodiments, the output ports for rerouting the receiver signals from the horizontal directions of all routing devices 808a-808d are communicatively coupled to a merging line 810b, which sums up the rerouted receiver signals from the horizontal direction 706a1, 706b2, 706c1, and 706d2. A second beam signal 812b may be generated from merging line 810b, and has a value of receiver signals (706a1+706b2+706c1+and 706d2).

Those skilled in the art will recognize improvements and modifications to the preferred embodiments of the present disclosure. All such improvements and modifications are considered within the scope of the concepts disclosed herein and the claims that follow.

What is claimed is:

1. A beamforming integrated circuit (BFIC), comprising:
a first port configured to receive a first radio frequency (RF) signal;
a second port configured to receive a second RF signal; and
one or more routing devices disposed between the first port and the second port, configured to route one of the first RF signal or the second RF signal to merge with another one of the first RF signal and the second RF signal in a merging line.

2. The BFIC of claim 1, wherein the first RF signal and the second RF signal are received at respective ports in different directions.

3. The BFIC of claim 1, wherein the first RF signal and the second RF signal are received at respective ports in a same direction.

4. The BFIC of claim 1, wherein the one or more routing device changes a transmission direction of at least one of the first RF signal or the second RF signal.

5. The BFIC of claim 1, wherein the one or more routing devices comprise:
a first routing device disposed between the first port and the merging line, configured to route the first RF signal to the merging line; and
a second routing device disposed between the second port and the merging line, configured to route the second RF signal to the merging line.

6. The BFIC of claim 5, wherein:
the first RF signal is transmitted from a first front-end module (FEM); and
the second RF signal is transmitted from a second FEM, the first FEM and the second FEM being aligned in a same direction.

7. The BFIC of claim 5, wherein:
the first RF signal is transmitted from a first front-end module (FEM); and
the second RF signal is transmitted from a second FEM, the first FEM and the second FEM being aligned in opposite directions.

8. The BFIC of claim 5, wherein the first RF signal and the second RF signal have a same polarization.

9. The BFIC of claim 5, further comprising:
a third port configured to receive a third RF signal that is transmitted in a different direction than the first RF signal; and
a fourth port configured to receive a fourth RF signal that is transmitted in a different direction than the second RF signal, wherein:
the first routing device is further configured to route the third RF signal to a second merging line; and
the second routing device is further configured to route the fourth RF signal to the second merging line.

10. The BFIC of claim 9, wherein the third RF signal and the fourth RF signal are received in respective ports in different directions.

11. The BFIC of claim 9, wherein the third RF signal and the fourth RF signal are received in respective ports in a same direction.

12. The BFIC of claim 9, wherein:
the first RF signal and the third RF signal are transmitted from a first FEM;
the second RF signal and the fourth RF signal are transmitted from a second FEM; and
the first FEM and the second FEM are aligned in a same direction.

13. The BFIC of claim 9, wherein:
the first RF signal and the third RF signal are transmitted from a first FEM;
the second RF signal and the fourth RF signal are transmitted from a second FEM; and
the first FEM and the second FEM are aligned in opposite directions.

14. The BFIC of claim 9, wherein the third RF signal and the fourth RF signal have a same polarization.

15. The BFIC of claim 1, wherein the one or more routing devices each comprises:
a first switch configured to be communicatively connected to one of the first RF signal or the second RF signal; and
a second switch configured to be communicatively connected to the first switch and the merging line.

16. The BFIC of claim 15, further comprising an on-chip RF crossover component communicatively connecting the first switch and the second switch.

17. The BFIC of claim 16, further comprising an electrical interface configured to receive a control signal for controlling a connection between the first switch and the second switch via the on-chip RF crossover component.

18. The BFIC of claim 15, wherein the first switch and the second switch comprise a single-pole-double-throw switch.

19. The BFIC of claim 1, wherein the one or more routing devices comprise silicon, gallium arsenide, gallium nitride, or a combination thereof.

20. A routing device, comprising:
a first switch configured to be communicatively connected to a radio frequency (RF) signal;
a second switch configured to be communicatively connected to the first switch and a merging line; and
an on-chip RF crossover component communicatively connecting the first switch and the second switch in response to a control signal.
